(19) United States
(12) Patent Application Publication
(10) Pub. No.: US 2024/0320982 A1
(43) Pub. Date: Sep. 26, 2024

(54) METHOD FOR MONITORING, DEVICE FOR MONITORING, VEHICLE TO EVERYTHING SERVER, AND STORAGE MEDIUM

(71) Applicant: FOXCONN INTERCONNECT TECHNOLOGY LIMITED, Grand Cayman (KY)

(72) Inventor: CHUNG-NAN KO, New Taipei (TW)

(21) Appl. No.: 18/225,716

(22) Filed: Jul. 25, 2023

(30) Foreign Application Priority Data
Mar. 20, 2023 (CN) 202310272672.7

(51) Int. Cl. G06V 20/56; G06V 20/52; H04W 4/40

(52) U.S. Cl. CPC G06V 20/56; G06V 20/52; H04W 4/40

(57) ABSTRACT

A method of monitoring is provided. The method obtains first images captured by surround-view cameras of preset vehicles in a monitoring area. Where each preset vehicle starts a sentinel mode, and each preset vehicle includes a surround-view camera. The method determines a second preset vehicle according to a second image if a suspicious target of a first preset vehicle appear in the second image, which is captured by the corresponding surround-view camera of the first preset vehicle and are from the first images, and a definition of the suspicious target in the second image is less than a preset value. Where the suspicious target appears in an illuminating area illuminated by a preset exterior lamp of the second preset vehicle. The method further prompts the second preset vehicle to turn on the preset exterior lamp. A related V2X server and a related storage medium are provided.

### FIELD

The subject matter herein generally relates to a vehicle to everything technology, and particularly to a method for monitoring, a device for monitoring, a vehicle to everything server, and a storage medium.

### BACKGROUND

Now, many vehicles have equipped sentinel modes. Each sentinel mode is configured to ensure a safety of a vehicle asset. In detail, when the sentinel model is started, a surround-view camera of the vehicle can start to monitor an ambient environment surrounding the vehicle. At the moment, a monitoring area of the vehicle can be the ambient environment surrounding the vehicle. When one or more suspicious targets (for example, one or more persons, one or more objects, or one or more things which cause one or more threats to the vehicle asset) appear in the ambient environment surrounding the vehicle, the vehicle can automatically turn on a preset exterior lamp of the vehicle such as a headlight of the vehicle or the like. Simultaneously, the surround-view camera of the vehicle can further automatically capture and store one or more videos, and further transmit the one or more videos or a prompt to the vehicle owner terminal such as a mobile phone or the like, to prompt the vehicle owner of the vehicle. Because the one or more suspicious targets in front of the vehicle can be illuminated by the preset exterior lamp of the vehicle, thus the one or more suspicious targets in front of the vehicle are clear in the video, However, the one or more suspicious targets on a left side, on a right side, or at a rear of the vehicle may be unclear in the video because of one or more reasons such as a relatively dark light and so on. Thus, a clear video cannot be recorded, and a loss of the vehicle asset may be caused.

### SUMMARY

An embodiment of the present application provides a method for monitoring, a device for monitoring, a vehicle to everything server, and a storage medium capable of providing lights for one or more suspicious targets and preventing subsequently captured video from being unclear.

In a first aspect, an embodiment of the present application provides a method for monitoring. A vehicle to everything server obtains a number of first images captured by a number of surround-view cameras of a number of preset vehicles from all the preset vehicles in a monitoring area. Where each of the preset vehicles starts a sentinel mode, each of the preset vehicles is provided with a corresponding surround-view camera, each of the surround-view cameras is configured to capture one or more first images of an ambient environment surrounding a corresponding preset vehicle, and each of the preset vehicles is provided with a preset exterior lamp. The vehicle to everything server determines one or more second preset vehicles according to one or more second images if one or more suspicious targets of a first preset vehicle appear in the one or more second images, which are captured by the corresponding surround-view camera of the first preset vehicle and are from the first images, and a definition of each of the one or more suspicious targets in each of the one or more second images is less than a preset value. Where the first preset vehicle is one preset vehicle in the monitoring area, the one or more second preset vehicles are one or more of the preset vehicles in the monitoring area. Each second preset vehicle is different from the first preset vehicle, and the one or more suspicious targets appear in an illuminating area illuminated by one or more preset exterior lamps of the one or more second preset vehicles. The vehicle to everything server prompts the one or more second preset vehicles to turn on the one or more preset exterior lamps.

According to some embodiments of the present application, the vehicle to everything server determines that the monitoring area is a union set of a number of ranges of image capturing of the surround-view cameras of all the preset vehicles.

According to some embodiments of the present application, the vehicle to everything server determines position information of the one or more suspicious targets according to the one or more second images. The vehicle to everything server determines that the one or more second preset vehicles are one or more preset vehicles of which the illuminating area includes the position information of the one or more suspicious targets. Where the illuminating area is illuminated by the one or more preset exterior lamps of the one or more preset vehicles, and the one or more preset vehicles are from all the preset vehicles in the monitoring area.

According to some embodiments of the present application, the one or more second preset vehicles are at different orientations of the first preset vehicle. The orientations in the different orientations of the first preset vehicle are from at least two of a group consisting of in front of the first preset vehicle, at a left side of the first preset vehicle, at a right side of the first preset vehicle, and at a rear of the first preset vehicle.

According to some embodiments of the present application, the vehicle to everything server determines one or more third preset vehicles excluding the first preset vehicle. Where at least one of the one or more suspicious targets of the first preset vehicle appear in one or more third images which are captured by one or more surround-view cameras of the one or more third preset vehicles and are from the first images, and the one or more third preset vehicles are from all the preset vehicles in the monitoring area. The vehicle to everything server prompts the one or more third preset vehicles to capture one or more videos via the one or more surround-view cameras of the one or more third preset vehicles. The vehicle to everything server obtains the one or more videos from the one or more third preset vehicles. The vehicle to everything server transmits the one or more videos to a vehicle owner terminal corresponding to the first preset vehicle.

According to some embodiments of the present application, the vehicle to everything server obtains one or more images captured by the corresponding surround-view camera of the first preset vehicle if the one or more suspicious targets of the first preset vehicle appear in the one or more second images which are captured by the corresponding surround-view camera of the first preset vehicle and are from the first images. Where the one or more suspicious targets of the first preset vehicle appears in the one or more images captured by the corresponding surround-view camera of the first preset vehicle, and the preset exterior lamp of the first preset vehicle is at a turned on state when the vehicle to everything server obtains the one or more images captured by the corresponding surround-view camera of the first preset vehicle. The vehicle to everything server determines that the one or more suspicious targets of the first preset vehicle appear in the one or more second images which are captured by the corresponding surround-view camera of the first preset vehicle and are from the first images and a definition of each of the one or more suspicious targets in each of the one or more second images is less than the preset value if the definition of each of the one or more suspicious targets in each of the one or more images captured by the corresponding surround-view camera of the first preset vehicle is less than the preset value.

According to some embodiments of the present application, the vehicle to everything server controls the surround-view cameras of all the preset vehicles in the monitoring area to track the one or more suspicious targets until the one or more suspicious targets exit from the monitoring area. The vehicle to everything server predicts one or more fourth preset vehicles of the preset vehicles during tracking. Where the one or more suspicious targets of the first preset vehicle appear in one or more images captured by one or more surround-view cameras of the one or more fourth preset vehicles. The vehicle to everything server predicts position information of the one or more suspicious targets of the first preset vehicle in the one or more images captured by the one or more surround-view cameras of the one or more fourth preset vehicles. The vehicle to everything server determines one or more fifth preset vehicles of the preset vehicles according to the predicted position information of the one or more suspicious targets of the first preset vehicle in the one or more images captured by the one or more surround-view cameras of the one or more fourth preset vehicles. Where the one or more suspicious targets of the first preset vehicle appear in an illuminating area illustrated by one or more preset exterior lamps of the one or more fifth preset vehicles.

In a second aspect, an embodiment of the present application provides a device for monitoring. The device for monitoring is applied on a vehicle to everything server. The device includes an obtaining module, a determining module, and a prompting module. The obtaining module is configured to obtain a number of first images captured by the surround-view cameras of the preset vehicles from all the preset vehicles in a monitoring area. Where each preset vehicle starts a sentinel mode, each preset vehicle is provided with a corresponding surround-view camera, each surround-view camera is configured to capture the one or more first images of the ambient environment surrounding the corresponding preset vehicle, and each preset vehicle is provided with a preset exterior lamp. The determining module is configured to determine one or more second preset vehicles according to one or more second images if one or more suspicious targets of the first preset vehicle appear in the one or more second images, which are captured by the corresponding surround-view camera of the first preset vehicle and are from the first images, and a definition of each suspicious target in each of the second images is less than the preset value. Where the first preset vehicle is one of the preset vehicles in the monitoring area, the one or more second preset vehicles are one or more preset vehicles in the monitoring area, each of the one or more second preset vehicles is different from the first preset vehicle, and the one or more suspicious targets appear in the illuminating area illuminated by the one or more preset exterior lamps of the one or more second preset vehicles. The prompting module is configured to prompt the one or more second preset vehicles to turn on the one or more preset exterior lamps.

In a third aspect, an embodiment of the present application provides a vehicle to everything server. The vehicle to everything server includes a storage device and at least one processor. The storage device stores one or more programs, which when executed by the at least one processor, cause the at least one processor to obtain a number of first images captured by a number of surround-view cameras of a number of preset vehicles from all the preset vehicles in a monitoring area. Where each preset vehicle starts a sentinel mode, each preset vehicle is provided with a corresponding surround-view camera, each surround-view camera is configured to capture one or more first images of an ambient environment surrounding a corresponding preset vehicle, and each preset vehicle is provided with a preset exterior lamp. The vehicle to everything server further causes the at least one processor to determine one or more second preset vehicles according to one or more second images if one or more suspicious targets of a first preset vehicle appear in the one or more second images, which are captured by the corresponding surround-view camera of the first preset vehicle and are from the first images, and a definition of each of the one or more suspicious targets in each of the one or more second images is less than a preset value. Where the first preset vehicle is one preset vehicle in the monitoring area, the one or more second preset vehicles are one or more preset vehicles in the monitoring area, each second preset vehicle is different from the first preset vehicle, and the one or more suspicious targets appear in an illuminating area illuminated by one or more preset exterior lamps of the one or more second preset vehicles. The vehicle to everything server further causes the at least one processor to prompt the one or more second preset vehicles to turn on the one or more preset exterior lamps.

In a fourth aspect, an embodiment of the present application provides a non-transitory storage medium. The non-transitory storage medium stores a set of commands, when the commands being executed by at least one processor of a vehicle to everything server, causing the at least one processor to obtain a number of first images captured by a number of surround-view cameras of a number of preset vehicles from all the preset vehicles in a monitoring area. Where each preset vehicle starts a sentinel mode, each preset vehicle is provided with a corresponding surround-view camera, each surround-view camera is configured to capture one or more first images of an ambient environment surrounding a corresponding preset vehicle, and each preset vehicle is provided with a preset exterior lamp. The non-transitory storage medium further causes the at least one processor to determine one or more second preset vehicles according to one or more second images if one or more suspicious targets of a first preset vehicle appear in the one or more second images, which are captured by the corresponding surround-view camera of the first preset vehicle and are from the first images, and a definition of each of the one or more suspicious targets in each of the one or more second images is less than a preset value. Where the first preset vehicle is one preset vehicle in the monitoring area, the one or more second preset vehicles are one or more preset vehicles in the monitoring area, each second preset vehicle is different from the first preset vehicle, and the one or more suspicious targets appear in an illuminating area illuminated by one or more preset exterior lamps of the one or more second preset vehicles. The non-transitory storage medium further causes the at least one processor to prompt the one or more second preset vehicles to turn on the one or more preset exterior lamps.

In the disclosure, the server obtains a number of first images captured by the surround-view cameras of the preset vehicles from all the preset vehicles which each starts the sentinel mode in the monitoring area. In the disclosure, the V2X server determines the one or more second preset vehicles according to the one or more second images if the one or more suspicious targets of the first preset vehicle appear in the one or more second images, which are captured by the corresponding surround-view camera of the first preset vehicle and are from the first images, and a definition of each suspicious target in each second image is less than the preset value. In the disclosure, the V2X server further prompts the one or more second preset vehicles to turn on the one or more preset exterior lamps. Where, the one or more suspicious targets appear in the illuminating area illuminated by the one or more preset exterior lamps of the one or more second preset vehicles. Thus, the one or more preset exterior lamps of other preset vehicles can illuminate the one or more suspicious targets of the first preset vehicle, subsequently, the one or more suspicious targets in the one or more videos captured by the first preset vehicle can be clear, thus a loss of the first preset vehicle asset may be avoided.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an application scenario view of an embodiment of a vehicle to everything server (V2X server).

FIG. 2 is a structure view of an embodiment of a V2X server.

FIG. 3 is a flowchart of an embodiment of a method for monitoring.

FIG. 4 is a view of an embodiment showing that a sentinel mode of a preset vehicle is started.

FIG. 5 is a view of an embodiment showing a surround-view camera of a preset vehicle.

FIG. 6 is a view of an embodiment showing a suspicious target contacting a preset vehicle.

FIG. 7 is a flowchart of an embodiment of a process of determining that one or more suspicious targets of a first preset vehicle appear in one or more second images which are from a number of first images and are captured by a corresponding surround-view camera of the first preset vehicle, and a definition of each suspicious target in each second image is less than a preset value.

FIG. 8 is a flowchart of an embodiment of a process of determining one or more second preset vehicles.

FIG. 9A is a view of an embodiment showing how to determine one or more second preset vehicles; FIG. 9B is a view of another embodiment showing how to determine one or more second preset vehicles; FIG. 9C is a view of the other embodiment showing how to determine one or more second preset vehicles.

FIG. 10 is a flowchart of an embodiment showing that other one or more preset vehicles each providing one or more videos via a V2X server.

FIG. 11 is a flowchart of an embodiment showing that one or more suspicious targets are tracked and monitored when the one or more suspicious targets move.

FIG. 12 is a block diagram of an embodiment of a device for monitoring.

### DETAILED DESCRIPTION

The term “for example” in the embodiments of this application is used to represent giving an example, an illustration, or a description. Any embodiment or implementation solution described as an “example” in this application should not be explained as being more preferred or having more advantages than another embodiment or implementation solution. Exactly, the term “example” is used to present a concept in a specific manner.

Unless otherwise defined, all technical and scientific terms used herein have the same meaning as commonly understood by one of ordinary skill in the art to which this application belongs. The terms used in the specification of this application are merely used for describing specific embodiments, and are not intended to limit this application. It should be understood that, unless otherwise noted, “a plurality of” in this application means two or more.

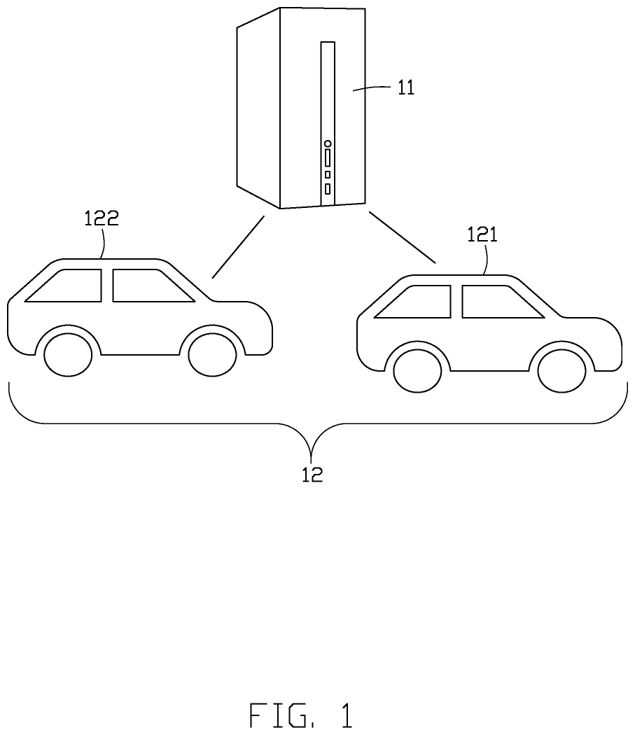

Referring to FIG. 1, FIG. 1 is an application scenario view of an embodiment of a V2X server. The V2X server 11 can be, for example a V2X platform which can manage one or more preset vehicles 12, or the like. A specific deployment form of the V2X server 11 can be a cloud deployment, a locally deployed computer device, or the like, the disclosure is not limited herein. The V2X server 11 can be a server or a server cluster, the disclosure is not limited herein.

The V2X server 11 can communicate with one or more preset vehicles 12. The V2X server 11 communicates with a base station (evolved Node B (eNodeB)) or a road side unit (RSU) over an evolved packet core (EPC). The base station or the RSU communicates with the preset vehicles 12 through vehicle to vehicle (V2V) communication or a Uu interface. The V2V may include a fifth prose communication interface (prose communication 5 (PC5)) and a dedicated short range communications (DSRC) interface. The Uu interface refers to an interface between the preset vehicles 12 and a universal terrestrial radio access network (universal mobile telecommunications system (UMTS) terrestrial radio access network (UTRAN)), and is an air interface of a UMTS.

Each preset vehicle 12 can be a vehicle which starts a sentinel mode. In some embodiments, each preset vehicle 12 can start the sentinel mode when a corresponding preset vehicle is shut down. Each preset vehicle 12 can include a corresponding surround-view camera. Each surround-view camera is configured to capture one or more first images of the ambient environment surrounding a corresponding preset vehicle 12. In some embodiments, each surround-view camera is configured to capture one or more first images which cooperatively provides information of 360 degrees ambient environment surrounding the corresponding preset vehicle 12. After each preset vehicle 12 starts the sentinel mode, each preset vehicle 12 can start to capture the one or more first images of the ambient environment surrounding the corresponding preset vehicle 12 via a corresponding surround-view camera. Each preset vehicle 12 can further start to capture the one or more videos via the corresponding surround-view camera when the corresponding preset vehicle detects that the one or more suspicious targets intrude the corresponding preset vehicle. Each preset vehicle 12 can include a preset exterior lamp. Each preset exterior lamp can be a headlight, or the like, the disclosure is not limited herein.

In some embodiments, after the V2X server 11 is started, the V2X server 11 can obtain a number of first images captured by the surround-view cameras of the preset vehicles 12 from the preset vehicles 12. When the one or more suspicious targets of a first preset vehicle 121 appear in one or more second images, which are captured by the corresponding surround-view camera of the first preset vehicle 121 and are from the first images, and a definition of each second image is less than a preset value, the V2X server 11 can determine one or more second preset vehicles 122 according to the one or more second images captured by the corresponding surround-view camera of the first preset vehicle 121. Namely, when the V2X server 11 detects that one or more suspicious targets intrude the first preset vehicle 121, and the one or more second images of the suspicious targets captured by the first preset vehicle 121 are unclear, the V2X server 11 determines the one or more second preset vehicles 122. Where, each second preset vehicle 122 is different from the first preset vehicle 121. And, the one or more suspicious targets of the first preset vehicle 121 appears in the illuminating area illuminated by the one or more preset exterior lamps of the one or more second preset vehicles 122. The V2X server 11 can prompt each second preset vehicle 122 to turn on the corresponding preset exterior lamp. Each second preset vehicle 122 can turn on the corresponding preset exterior lamp according to the prompt. Thus, when the first preset vehicle 121 captures the one or more videos, the one or more suspicious targets are illuminated, thus the one or more suspicious targets in the one or more videos captured by the first preset vehicle 121 is clear.

It can be understood that, a position relationship between the preset vehicles is merely illustrative, an actual position relationship between the preset vehicles can be other position relationship; two preset vehicles are illustrated in FIG. 1, but an actual number of the preset vehicles can be more than two, the disclosure is not limited herein.

It can be understood that, each preset vehicle can be represented by another terminal or another device which is associated or coupled with the corresponding preset vehicle. For example, each preset vehicle can be represented by an in-vehicle terminal, such as a mobile phone, which is installed in the corresponding preset vehicle. Or, each preset vehicle can be represented by a device, for example an in-vehicle unit or in-vehicle infotainment, which is integrated into the corresponding preset vehicle.

Referring to FIG. 2, FIG. 2 is a structure view of an embodiment of a V2X server. The V2X server may be a single physical device, or it may comprise multiple devices, such as two or more physically-distinct computers or the like, which may be connected to each other by a data network.

The V2X server 20 can include a storage unit 21, a processor 22, a display 23, and a communication interface 24. A person skilled in the art may understand that, the structure shown in FIG. 2 imposes no limitation on the V2X server 20, and the V2X server 20 may include more or fewer components than those shown in the figure, or combine some components, or divide some components, or have different component arrangements.

The storage unit 21 may be configured to store a software program and module/unit. The processor 22 runs the software program and module/unit stored in the storage unit 21, and invokes the data stored in the storage unit 21, to implement various functions of the V2X server 20. The storage unit 21 may include a program storage area and a data storage area. The program storage area may store an operating system, an application program required by at least one function (such as an image display function), and the like. The data storage area may store data (such as the second vehicle and so on) created according to use of the V2X server 20, and the like. In addition, the storage unit 21 may include a non-transitory storage medium, such as a hard disk, a memory, or the like. It can be understood that, the storage unit 21 may further include a non-transitory storage medium, such as a pluggable hard disk, a smart media card (SMC), a secure digital (SD) card, a flash card, at least one magnetic disk storage device, a flash storage unit, or another volatile solid-state storage device.

The processor 22 can include one or more central processing units (CPUs), and further include one or more general-purpose processors, one or more digital signal processors (DSPs), one or more application specific integrated circuits (ASICs), one or more field-programmable gate arrays (FPGAs), or other one or more programmable logic devices, one or more discrete gates or transistor logics, one or more discrete hardware components, and so on. The processor 22 can be a microprocessor or the processor 22 can be any conventional processor. The processor 22 is the control center of the V2X server 20, and is connected to various parts of the V2X server 20 by using various interfaces and lines.

The display 23 may be configured to display data and so on. The display 23 may include a display panel. Optionally, the display panel may be a liquid crystal display (LCD), an organic light-emitting diode (OLED), a flexible display panel, a plasma display panel, or the like. It can be understood that, the display 23 can be a display of a physical device of the V2X server 20, for example a display of a computer of the V2X server 20, the disclosure is not limited herein. It can be understood that, the display 23 can further be configured to receive an input from the user. The display 23 can further include a touch panel, the disclosure is not limited herein.

The communication interface 24 can include a Uu interface, a PC5 interface, or the like. The communication interface 24 can allow the V2X server 20 to communicate with a preset vehicle.

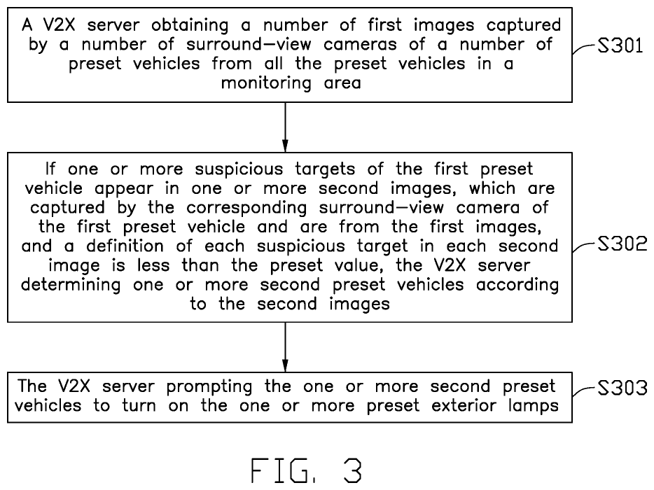

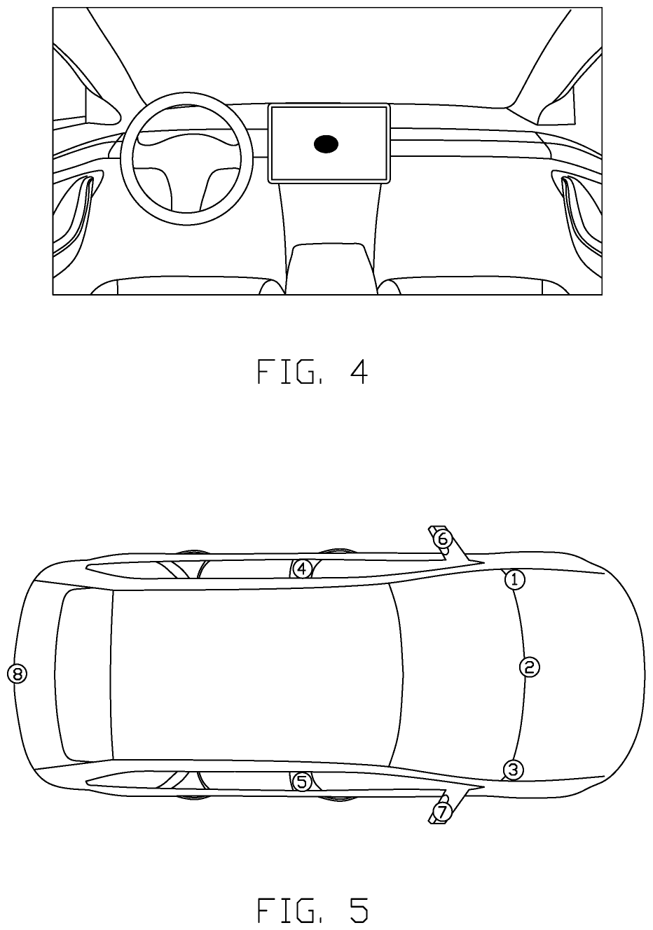

Referring to FIG. 3, FIG. 3 is a flowchart of an embodiment of a method for monitoring. The method for monitoring is applied on the V2X server of FIG. 2. The method for monitoring includes:

Step S301, V2X server obtaining a number of first images captured by a number of surround-view cameras of a number of preset vehicles from all the preset vehicles in a monitoring area.

In some embodiments, each preset vehicle can start a sentinel mode. In some embodiments, each preset vehicle can start the sentinel mode when a corresponding preset vehicle is shut down. When each preset vehicle starts the sentinel mode, each preset vehicle can display a red icon of the sentinel mode. In FIG. 4, the preset vehicle displays the icon of the sentinel mode via the in-vehicle unit of the preset vehicle. It can be understood that, the icon of the sentinel mode displayed in FIG. 4 is black, but in actual practice the icon of the sentinel mode is red, the disclosure is not limited herein. It can be understood that, the icon of the sentinel mode in FIG. 4 is displayed on the in-vehicle infotainment of the preset vehicle, but the icon of the sentinel mode can be also displayed via a mobile phone installed on the preset vehicle, the disclosure is not limited herein.

In some embodiments, each preset vehicle can include a surround-view camera. A field of view of each surround-view camera can reach 360 degrees. Each surround-view camera includes a number of cameras. The cameras of each surround-view camera are respectively installed on a vehicle front end of the corresponding preset vehicle, a vehicle rear end of the corresponding preset vehicle, a left side region of the corresponding preset vehicle, and a right side region of the corresponding preset vehicle. As shown in FIG. 5, the number of the cameras of each surround-view camera is eight, respectively a camera \textcircled{1}, a camera \textcircled{2}, a camera \textcircled{3}, a camera \textcircled{4}, a camera \textcircled{5}, a camera \textcircled{6}, a camera \textcircled{7}, and a camera \textcircled{8}. Where the camera \textcircled{1}, the camera \textcircled{2}, and the camera \textcircled{3} are installed on the vehicle front end of the corresponding preset vehicle. The camera \textcircled{4} and the camera \textcircled{6} are installed on the left side region of the corresponding preset vehicle. The camera \textcircled{5} and the camera \textcircled{7} are installed on the right side region of the corresponding preset vehicle. The camera \textcircled{8} is installed on the vehicle rear end of the corresponding preset vehicle. The camera \textcircled{1}, the camera \textcircled{2}, and the camera \textcircled{3} are respectively a wide angle lens, a narrow angle lens, and a master lens. The camera \textcircled{4} and the camera \textcircled{6} are respectively arranged on a left view mirror of the corresponding preset vehicle and a left B-pillar of the corresponding preset vehicle. The camera \textcircled{5} and the camera \textcircled{7} are respectively arranged on a right view mirror of the corresponding preset vehicle and a right B-pillar of the corresponding preset vehicle. It can be understood that, the surround-view camera in FIG. 5 is merely illustrative, the number and the installing positions of the cameras of each surround-view camera can be other number and other installing positions, the disclosure is not limited herein.

In some embodiments, after starting the sentinel mode, each preset vehicle can automatically capture the one or more first images of the ambient environment surrounding the corresponding preset vehicle via itself surround-view camera. Thus, all the preset vehicles in the monitoring area can automatically capture the one or more first images of these ambient environments via these surround-view cameras. And the V2X server can automatically obtain the first images captured by the surround-view cameras of the preset vehicles from all the preset vehicles in the monitoring area.

In some embodiments, each preset vehicle can include a preset exterior lamp. Each preset exterior lamp can be a headlight. Each headlight can be a front lighting lamp of the corresponding preset vehicle. Each preset exterior lamp is configured to provide lights. It can be understood that, each preset exterior lamp can be other exterior lamp, the disclosure is not limited herein.

In some embodiments, before the V2X server obtaining the first images captured by the surround-view cameras of the preset vehicles from all the preset vehicles in the monitoring area, the method further includes a step al. The step al includes the V2X server obtaining the monitoring area.

In some embodiments, the V2X server obtaining the monitoring area can include a step b1. The step b1 can include the V2X server determining that the monitoring area is a union set of a number of ranges of image capturing of the surround-view cameras of all the preset vehicles. In some embodiments, the V2X server obtaining the monitoring area can include a step c1 and a step c2. The step c1 includes the V2X server determining a number of preset vehicles which is from all the preset vehicle and in which a distance between each two adjacent preset vehicles is less than a preset value. The step c2 includes the V2X server determining that the monitoring area is the union set of a number of ranges of image capturing of the surround-view cameras of the determined preset vehicles. Thus, the V2X server can automatically combine the vehicles whose sentinel models each is started, and to form a new monitoring area. It can be understood that, the monitoring area can further be an area providing for a parking of the vehicle, for example a preset parking lot, and so on. And, the monitoring area can include not only the preset vehicles, but also not preset vehicles (vehicles whose sentinel modes are not started), the disclosure is not limited herein.

Step S302, if one or more suspicious targets of the first preset vehicle appear in one or more second images, which are captured by the corresponding surround-view camera of the first preset vehicle and are from the first images, and a definition of each suspicious target in each second image is less than the preset value, the V2X server determining one or more second preset vehicles according to the second images.

In some embodiments, each second image includes one or more suspicious targets of the first preset vehicle. In some embodiments, the one or more suspicious targets of the first preset vehicle can be one or more persons, one or more objects, or one or more things which cause one or more threats to the first preset vehicle. These persons, these objects, or these things may cause a loss of the first preset vehicle asset. As shown in FIG. 6, the one or more suspicious targets 602 of the first preset vehicle 601 can be a person who contacts the first preset vehicle. It can be understood that, the one or more suspicious targets of the first preset vehicle in FIG. 6 is merely illustrative, the one or more suspicious targets of the first preset vehicle can further be one or more persons who scratch or impact the first preset vehicle, or the one or more persons who break a window of the first preset vehicle, the disclosure is not limited herein.

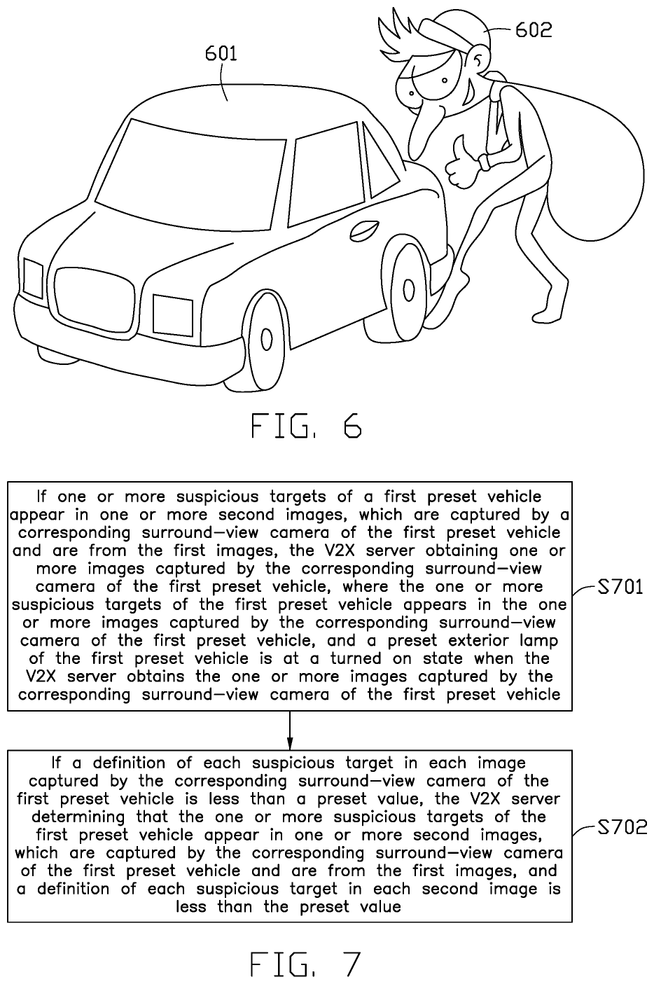

In some embodiments, as shown in FIG. 7, the V2X server determining that the one or more suspicious targets of the first preset vehicle appear in one or more second images, which are captured by the corresponding surround-view camera of the first preset vehicle and are from the first images, and a definition of each suspicious target in each second image is less than the preset value includes:

S701, if the one or more suspicious targets of the first preset vehicle appear in one or more second images, which are captured by the corresponding surround-view camera of the first preset vehicle and are from the first images, the V2X server obtaining one or more images captured by the corresponding surround-view camera of the first preset vehicle, where the one or more suspicious targets of the first preset vehicle appears in the one or more images captured by the corresponding surround-view camera of the first preset vehicle, and the preset exterior lamp of the first preset vehicle is at a turned on state when the V2X server obtains the one or more images captured by the corresponding surround-view camera of the first preset vehicle.

In some embodiments, each preset vehicle can automatically turn on the corresponding preset exterior lamp when the corresponding preset vehicle monitors that the one or more suspicious targets of the corresponding preset vehicle appear in the first images captured by the surround-view camera of the corresponding preset vehicle. Each preset vehicle can further continuously monitor the ambient environment via the surround-view camera of the corresponding preset vehicle. At the moment, the preset exterior lamp of each preset vehicle can illuminate a preset area in front of the corresponding preset vehicle, thus the preset area in front of the corresponding preset vehicle is clear in the image, but an area at a left side of the corresponding preset vehicle, an area at a right side of the corresponding preset vehicle, or an area at a rear of the corresponding preset vehicle is unclear in the image. Thus, the preset exterior lamp of the first preset vehicle is at a turned on state when the V2X server obtains again the one or more images captured by the corresponding surround-view camera of the first preset vehicle.

S702, if a definition of each suspicious target in each image captured by the corresponding surround-view camera of the first preset vehicle is less than the preset value, the V2X server determining that the one or more suspicious targets of the first preset vehicle appear in one or more second images, which are captured by the corresponding surround-view camera of the first preset vehicle and are from the first images, and a definition of each suspicious target in each second image is less than the preset value.

In some embodiments, when the preset exterior lamp of the first preset vehicle is at a turned on state, if the one or more suspicious targets of the first preset vehicle are in front of the first preset vehicle, the definition of the one or more suspicious targets of the first preset vehicle in the one or more images captured by the corresponding surround-view camera of the first preset vehicle are greater than the preset value. However, when the preset exterior lamp of the first preset vehicle is at a turned on state, if the one or more suspicious targets of the first preset vehicle are on a left side of the first preset vehicle, on a right side of the first preset vehicle, or at a rear of the first preset vehicle, the definition of each suspicious target in the one or more images captured by the corresponding surround-view camera of the first preset vehicle is less than the preset value.

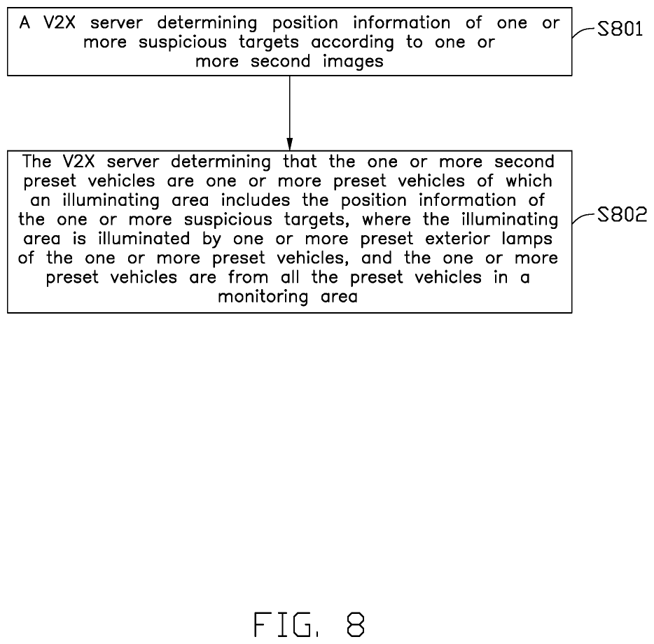

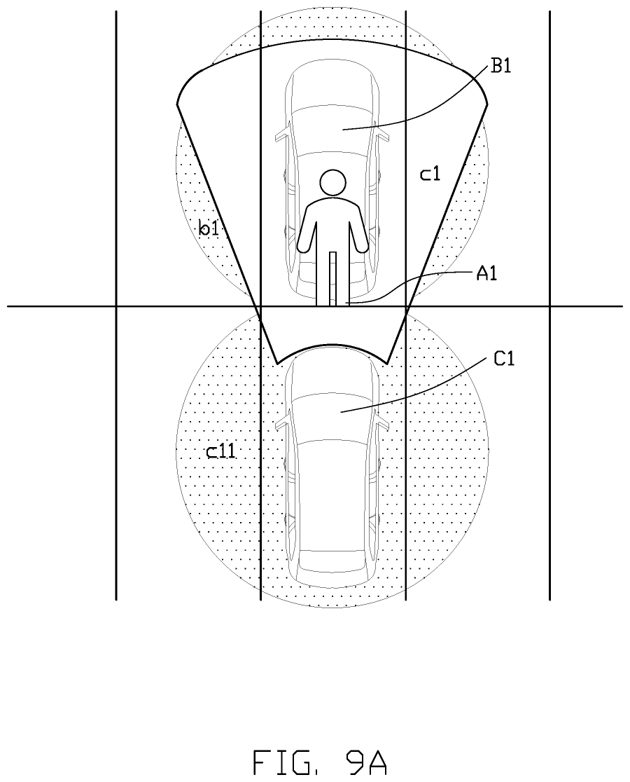

In some embodiments, as shown in FIG. 8, the V2X server determining one or more second preset vehicles according to the one or more second images includes:

S801, the V2X server determining position information of the one or more suspicious targets according to the one or more second images.

In some embodiments, the position information of the one or more suspicious targets can be detected by the V2X server via obtaining the position information of the one or more suspicious targets from the first preset vehicle. In some embodiments, the first preset vehicle can determine a spatial coordinate set of each suspicious target. Where, the first preset vehicle can determine the spatial coordinate set of each suspicious target in a camera coordinate system according to the one or more second images via the in-vehicle infotainment, or the like. The first preset vehicle can further determine the spatial coordinate set of each suspicious target in a world coordinate system according to the spatial coordinate set of each suspicious target in the camera coordinate system via the in-vehicle infotainment, or the like. It can be understood that, the manner that the first preset vehicle determining the spatial coordinate set of each suspicious target can be other manners, for example the first preset vehicle directly determines the spatial coordinate set of each suspicious target in the world coordinate system, the disclosure is not limited herein.

In some embodiments, the position information of the one or more suspicious targets can be detected by the V2X server via calculating the position information of the one or more suspicious targets. In detail, the V2X server can determine the spatial coordinate set of each suspicious target in the world coordinate system according to the one or more second images. The method that the V2X server determines the spatial coordinate set of each suspicious target in the world coordinate system according to the one or more second images can be, for example the V2X server determining the spatial coordinate set of each suspicious target in the camera coordinate system according to the one or more second images, and determining the spatial coordinate set of each suspicious target in the world coordinate system according to the spatial coordinate set of each suspicious target in the camera coordinate system. It can be understood that, the manner that the V2X server determining the spatial coordinate set of each suspicious target can be other manners, the disclosure is not limited herein.

It can be understood that, the position information of each suspicious target can further be a relative positional relation between a corresponding suspicious target and the first preset vehicle, for example a suspicious target 1 is on a 3 decimeters left side of the first preset vehicle, the disclosure is not limited herein.

S802, the V2X server determining that the one or more second preset vehicles are one or more preset vehicles of which the illuminating area includes the position information of the one or more suspicious targets, where the illuminating area is illuminated by the one or more preset exterior lamps of the one or more preset vehicles, and the one or more preset vehicles are from all the preset vehicles in the monitoring area.

In some embodiments, the V2X server determining that the one or more second preset vehicles are one or more preset vehicles of which the illuminating area includes the position information of the one or more suspicious targets includes a step d1, a step d2, and a step d3. The step d1 includes the V2X server determining a number of first illuminating areas illuminated by the preset exterior lamps of all the preset vehicles in the monitoring area. The step d2 includes the V2X server determining one or more second illuminating areas, where the one or more second illuminating areas includes the position information of the one or more suspicious targets and the one or more second illuminating areas are from the first illuminating areas. The step d3 includes the V2X server determining that the one or more second preset vehicles are the one or more preset vehicles corresponding to the one or more second illuminating areas.

It can be understood that, the areas which do not include the position information of the one or more suspicious targets are excluded from the second illuminating areas.

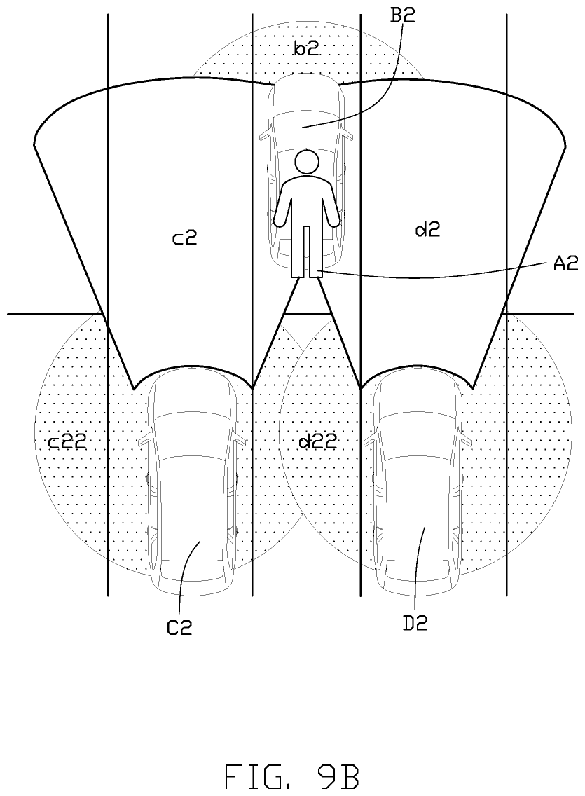

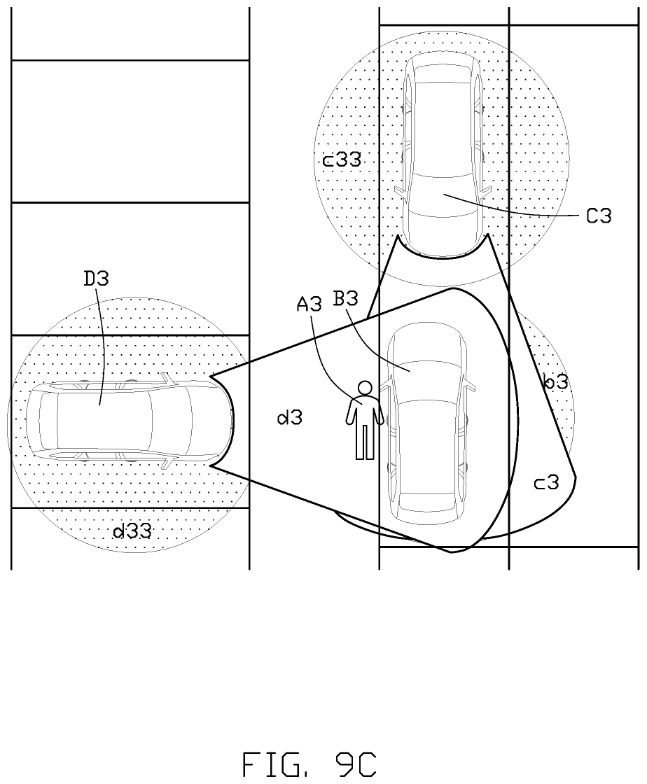

In some embodiments, as shown in FIG. 9A, the one or more second preset vehicles can be a preset vehicle directly behind the first preset vehicle. In FIG. 9A, two preset vehicles are in the monitoring area. The two preset vehicles include at least one first preset vehicle B1, and the other preset vehicle C1 is directly behind the first preset vehicle B1. In FIG. 9A, a suspicious target A1 of the first preset vehicle B1 is directly behind the first preset vehicle B1 in the monitoring area, a capturing range of the corresponding surround-view camera of the first preset vehicle B1 is an area b1, an illuminating area illuminated by the preset exterior lamp of the preset vehicle C1 in the monitoring area is an area c1, and a capturing range of the surround-view camera of the preset vehicle C1 is an area c11. Where, the area b1 and the area c11 each is substantially circular, and each is illustrated using a number of gray points. The area cl is substantially sector-shaped, and is illustrated using a white. From FIG. 9A, it can be see that, the suspicious target A1 is within the illuminating area c1 illuminated by the preset exterior lamp of the preset vehicle C1, thus the one or more second preset vehicles can be the preset vehicle C1, and the second preset vehicle can provide sufficient lights for the suspicious target A1, therefore the first preset vehicle B1 can clearly capture the image or the video of the suspicious target Al. It can be understood that, in FIG. 9A, if the suspicious target is at a left side of the first preset vehicle B1 or at a right side of the first preset vehicle B1, the preset vehicle C1 can provide sufficient lights for the suspicious target at the left side of the first preset vehicle B1 or at the right side of the first preset vehicle B1, the disclosure is not limited herein.

In some embodiments, as shown in FIG. 9B, the one or more second preset vehicles can be two preset vehicles at a side rear of the first preset vehicle. In FIG. 9B, three preset vehicles are in the monitoring area. The three preset vehicles include at least one first preset vehicle B2, and the other two preset vehicles C2 and D2 are respectively at a left side rear of the first preset vehicle B2 and a right side rear of the first preset vehicle B2. In FIG. 9B, a suspicious target A2 of the first preset vehicle B2 is directly behind the first preset vehicle B2 in the monitoring area, a capturing range of the corresponding surround-view camera of the first preset vehicle B2 is an area b2, an illuminating area illuminated by the preset exterior lamp of the preset vehicle C2 is an area c2, a capturing range of the surround-view camera of the preset vehicle C2 is an area c22, an illuminating area illuminated by the preset exterior lamp of the preset vehicle D2 is an area d2, and a capturing range of the surround-view camera of the preset vehicle D2 is an area d22. Where, the area b2, the area c22, and the area d22 each is substantially circular, and each is illustrated using a number of gray points. The area c2 and the area d2 each is substantially sector-shaped, and each is illustrated using the white. From FIG. 9B, it can be see that, the suspicious target A2 is within the union set of the illuminating area c2 illuminated by the preset exterior lamp of the preset vehicle C2 and the illuminating area d2 illuminated by the preset exterior lamp of the preset vehicle D2, thus the one or more second preset vehicles are the preset vehicle C2 and the preset vehicle D2, and the one or more second preset vehicles can provide sufficient lights for the suspicious target A2, therefore the first preset vehicle B2 can clearly capture the image or the video of the suspicious target A2. It can be understood that, in FIG. 9B, if the suspicious target is at the left side of the first preset vehicle B2 or at the right side of the first preset vehicle B2, the preset vehicle C2 and the preset vehicle D2 can provide sufficient lights for the suspicious target of the first preset vehicle B2 at a left side of the first preset vehicle B2 or at a right side of the first preset vehicle B2, the disclosure is not limited herein.

In some embodiments, as shown in FIG. 9C, the one or more second preset vehicles can be two preset vehicles respectively in front of the first preset vehicle and at a left side of the first preset vehicle. In FIG. 9C, three preset vehicles are in the monitoring area. The three preset vehicles include at least one first preset vehicle B3, and the other two preset vehicles C3 and D3 are respectively in front of the first preset vehicle B3 and at a left side of the first preset vehicle B3. In FIG. 9C, a suspicious target A3 is at a left side of the first preset vehicle B3 in the monitoring area, a capturing range of the corresponding surround-view camera of the first preset vehicle B3 is an area b3, an illuminating area illuminated by the preset exterior lamp of the preset vehicle C3 is an area c3, a capturing range of the surround-view camera of the preset vehicle C3 is an area c33, an illuminating area illuminated by the preset exterior lamp of the preset vehicle D3 is an area d3, and a capturing range of the surround-view camera of the preset vehicle D3 is an area d33. Where, the area b3, the area c33, and the area d33 each is substantially circular, and each is illustrated using a number of gray points. The area c3 and the area d3 each is substantially sector-shaped, and each is illustrated using the white. From FIG. 9C, it can be see that, the suspicious target A3 is within the union set of the illuminating area c3 illuminated by the preset exterior lamp of the preset vehicle C3 and the illuminating area d3 illuminated by the preset exterior lamp of the preset vehicle D3, thus the one or more second preset vehicles are the preset vehicle C3 and the preset vehicle D3, and the one or more second preset vehicle can provide sufficient lights for the suspicious target A3, therefore the first preset vehicle B3 can clearly capture the image or the video of the suspicious target A3. It can be understood that, in FIG. 9C, if the suspicious target is at a left side of the first preset vehicle B3 or at a right side of the first preset vehicle B3, the preset vehicle C3 and the preset vehicle D3 can provide sufficient lights for the suspicious target of the first preset vehicle B3 at a right side of the first preset vehicle B3, in front of the first preset vehicle B3, or at a rear of the first preset vehicle B3, the disclosure is not limited herein.

From FIG. 9C, it can be seen that, the one or more second preset vehicles can be at different orientations of the first preset vehicle. The orientations in the different orientations of the first preset vehicle can be from at least two of a group consisting of in front of the first preset vehicle, at the left side of the first preset vehicle, at the right side of the first preset vehicle, and at the rear of the first preset vehicle.

It can be understood that, the method of the V2X server determining the second preset vehicle can be other methods, for example, the detecting the position information of the one or more suspicious targets is omitted and the method can directly determine that each suspicious target is near a position edge region of the first preset vehicle, thus the method can determine the one or more position edge regions of the first preset vehicle corresponding to the one or more suspicious targets according to the one or more second images, and determine that the one or more second vehicles are the one or more preset vehicles of which the illuminating area includes the one or more position edge regions of the first preset vehicle, where the illuminating area is illuminated by the one or more preset exterior lamps of the one or more preset vehicles, and the one or more preset vehicles are from all the preset vehicles in the monitoring area, the disclosure is not limited herein.

Step S303, the V2X server prompting the one or more second preset vehicles to turn on the one or more preset exterior lamps.

In some embodiments, the V2X server can prompt each in-vehicle terminal installed on the corresponding second preset vehicle to turn on the corresponding preset exterior lamp, or prompt each in-vehicle unit or each in-vehicle infotainment integrated into the corresponding second preset vehicle to turn on the corresponding preset exterior lamp.

In some embodiments, after the V2X server prompting each second preset vehicle to turn on the corresponding preset exterior lamp, each second preset vehicle can turn on the corresponding preset exterior lamp, thus the one or more second preset vehicles can illuminate the one or more suspicious targets of the first preset vehicle.

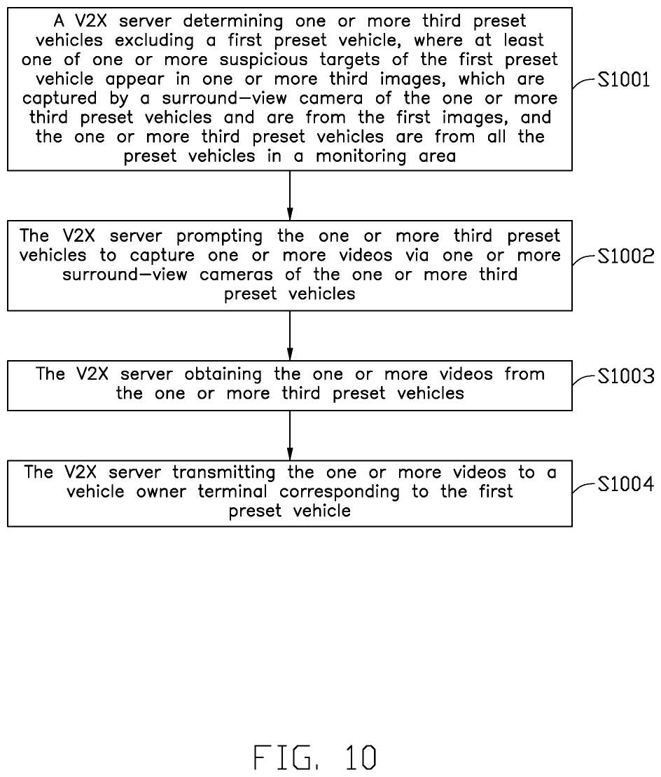

In some embodiments, each preset vehicle can automatically turn on the corresponding preset exterior lamp when each preset vehicle detects that the one or more suspicious targets of the corresponding preset vehicle appear in the one or more first images captured by the surround-view camera of the corresponding preset vehicle, and continuously monitor the ambient environment via the surround-view camera of the corresponding preset vehicle, for example capturing the one or more videos of the ambient environment. Each preset vehicle further stores the one or more videos, and transmits the one or more videos to or prompts the vehicle owner terminal, thus the vehicle owner of each preset vehicle can know an existence of the one or more suspicious targets of the corresponding preset vehicle. Even, the vehicle owner of each preset vehicle can clearly view the one or more suspicious targets of the corresponding preset vehicle. In some embodiments, as shown in FIG. 10, to view the one or more suspicious targets clearer, after the V2X server prompts the one or more second preset vehicles to turn on the one or more preset exterior lamps, the method further includes:

S1001, the V2X server determining one or more third preset vehicles excluding the first preset vehicle, where at least one of the one or more suspicious targets of the first preset vehicle appear in one or more third images, which are captured by the surround-view camera of the one or more third preset vehicles and are from the first images, and the one or more third preset vehicles are from all the preset vehicles in the monitoring area.

S1002, the V2X server prompting the one or more third preset vehicles to capture the one or more videos via the one or more surround-view cameras of the one or more third preset vehicles.

S1003, the V2X server obtaining the one or more videos from the one or more third preset vehicles.

S1004, the V2X server transmitting the one or more videos to the vehicle owner terminal corresponding to the first preset vehicle.

Thus, the V2X server can provide one or more videos of at least one of the one or more suspicious targets from another perspective for the vehicle owner of the first preset vehicle via other preset vehicles excluding the first preset vehicle, thus the vehicle owner of the first preset vehicle can view the at least one of the one or more suspicious targets clearer.

It can be understood that, the one or more third preset vehicles can be the same as the one or more second preset vehicles. Namely, the V2X server determines that the one or more second preset vehicles are the one or more preset vehicles satisfying a first preset condition and a second preset condition when the V2X server determines the one or more second preset vehicles. The first preset condition includes that the illuminating area illuminated by the one or more preset exterior lamps of the one or more second preset vehicles includes the position information of the one or more suspicious targets. The second preset condition includes that at least one of the one or more suspicious targets of the first preset vehicle appears in the one or more fourth images captured by the one or more surround-view cameras of the one or more second preset vehicles, the disclosure is not limited herein.

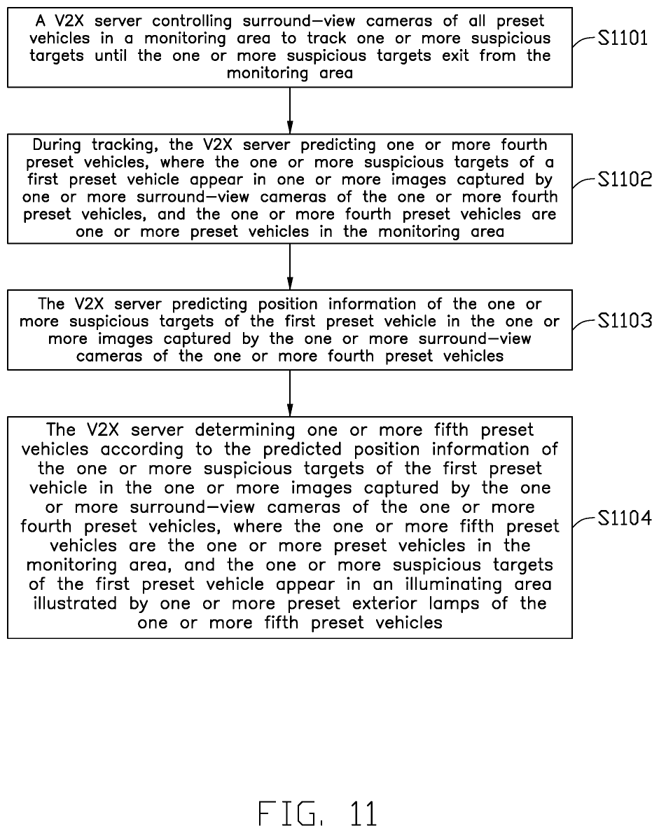

In some embodiments, the V2X server can automatically indicate to switch to other one or more preset vehicles to provide lights for the one or more suspicious targets when the one or more positions of the one or more suspicious targets of the first preset vehicle change. In detail, as shown in FIG. 11, after the V2X server prompts the one or more second preset vehicles to turn on the one or more preset exterior lamps, the method further includes:

S1101, the V2X server controlling the surround-view cameras of all the preset vehicles in the monitoring area to track the one or more suspicious targets until the one or more suspicious targets exit from the monitoring area.

In some embodiments, the one or more suspicious targets exit from the monitoring area can be that the one or more suspicious targets do not appear in the one or more images or the one or more videos captured by the surround-view camera of any preset vehicle in the monitoring area.

S1102, during tracking, the V2X server predicting one or more fourth preset vehicles, where the one or more suspicious targets of the first preset vehicle appear in the one or more images captured by the one or more surround-view cameras of the one or more fourth preset vehicles, and the one or more fourth preset vehicles are the one or more preset vehicles in the monitoring area.

S1103, the V2X server predicting position information of the one or more suspicious targets of the first preset vehicle in the one or more images captured by the one or more surround-view cameras of the one or more fourth preset vehicles.

S1104, the V2X server determining one or more fifth preset vehicles according to the predicted position information of the one or more suspicious targets of the first preset vehicle in the one or more images captured by the one or more surround-view cameras of the one or more fourth preset vehicles, where the one or more fifth preset vehicles are the one or more preset vehicles in the monitoring area, and the one or more suspicious targets of the first preset vehicle appear in an illuminating area illustrated by one or more preset exterior lamps of the one or more fifth preset vehicles.

In some embodiments, a first process of the V2X server determining one or more fifth preset vehicles according to the predicted position information of the one or more suspicious targets of the first preset vehicle in the one or more images captured by the one or more surround-view cameras of the one or more fourth preset vehicles, is similar to a second process of the V2X server determining one or more second preset vehicles according to the second images, which will not be described herein. It can be understood that, during tracking, because the one or more suspicious targets may move in the monitoring area, the one or more fourth preset vehicles may be changed, for example may be changed from a vehicle E to a vehicle F, the disclosure is not limited herein.

Thus, the V2X server can track the one or more suspicious targets of the first preset vehicle in real time, and provide lights for the one or more suspicious targets of the first preset vehicle.

In some embodiments, the V2X server further prompts the one or more fourth preset vehicles to capture the one or more videos via the one or more surround-view cameras of the one or more fourth preset vehicles, obtains the one or more videos from the one or more fourth preset vehicles, and transmits the one or more videos to the vehicle owner terminal corresponding to the first preset vehicle. Thus, the V2X server can further provide a movement path of each of the one or more suspicious targets of the first preset vehicle for the vehicle owner of the first preset vehicle, and it is convenient for the vehicle owner of the first preset vehicle to view a detail.

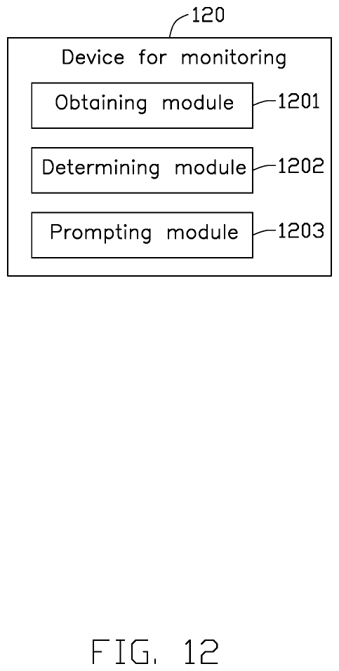

Referring to FIG. 12, FIG. 12 is a block diagram of an embodiment of a device for monitoring. The device for monitoring 120 includes an obtaining module 1201, a determining module 1202, and a prompting module 1203. The obtaining module 1201 is configured to obtain a number of first images captured by the surround-view cameras of the preset vehicles from all the preset vehicles in a monitoring area, where each preset vehicle starts a sentinel mode, each preset vehicle includes a corresponding surround-view camera, each surround-view camera is configured to capture the one or more first images of the ambient environment surrounding the corresponding preset vehicle, and each preset vehicle includes a preset exterior lamp. The determining module 1202 is configured to determine one or more second preset vehicles according to one or more second images if one or more suspicious targets of the first preset vehicle appear in the one or more second images, which are captured by the corresponding surround-view camera of the first preset vehicle and are from the first images, and a definition of each suspicious target in each of the second images is less than the preset value, where the first preset vehicle is one of the preset vehicles in the monitoring area, the one or more second preset vehicles are one or more preset vehicles in the monitoring area, each of the one or more second preset vehicles is different from the first preset vehicle, and the one or more suspicious targets appear in the illuminating area illuminated by the one or more preset exterior lamps of the one or more second preset vehicles. The prompting module 1203 is configured to prompt the one or more second preset vehicles to turn on the one or more preset exterior lamps.

It can be understood that, the device for monitoring can be varied to other embodiments, a detail can be referred to a method for monitoring as shown in FIG. 3, which will not be described herein.

In some embodiments, the embodiment of the present document further provides a computer storage medium where computer executable instructions are stored herein, the computer executable instructions are used by the V2X server for executing the method for monitoring in FIG. 3.

The embodiment relates to a computer program product comprising one or more computer executable instructions, the computer executable instructions are stored in the computer storage medium. One or more processors of a V2X server can read the computer executable instructions from the computer storage medium. The one or more processors can execute the one or more computer executable instructions to accomplish the steps of the method for monitoring in FIG. 3.

In the disclosure, the V2X server obtains a number of first images captured by the surround-view cameras of the preset vehicles from all the preset vehicles which each starts the sentinel mode in the monitoring area. In the disclosure, the V2X server determines the one or more second preset vehicles according to the one or more second images if the one or more suspicious targets of the first preset vehicle appear in the one or more second images, which are captured by the corresponding surround-view camera of the first preset vehicle and are from the first images, and a definition of each suspicious target in each second image is less than the preset value. In the disclosure, the V2X server further prompts the one or more second preset vehicles to turn on the one or more preset exterior lamps. Where, the one or more suspicious targets appear in the illuminating area illuminated by the one or more preset exterior lamps of the one or more second preset vehicles. Thus, the one or more preset exterior lamps of other preset vehicles can illuminate the one or more suspicious targets of the first preset vehicle, subsequently, the one or more suspicious targets in the one or more videos captured by the first preset vehicle can be clear, thus a loss of the first preset vehicle asset may be avoided.

In the several embodiments provided in the present application, it should be understood that the disclosed device and method may be implemented in other manners. For example, the described device embodiment is merely exemplary. For example, the module division or the unit division is merely a logical function division and there may be other bases of division in actual implementation. For example, multiple units or components may be combined or integrated into another device, or some features may be ignored or not performed.

In addition, functional units in the embodiments of the present invention may be integrated into one processing unit, or each of the units may exist alone physically, or two or more units are integrated into one unit.

Based on the description of the foregoing implementation manners, a person skilled in the art may clearly understand that the present disclosure may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented using corresponding hardware. Moreover, a specific hardware structure used to achieve a same function may be of various forms, for example, in a form of an analog circuit, a digital circuit, a dedicated circuit, or the like. However, as for the present disclosure, software program implementation is a better implementation manner in most cases. Based on such an understanding, the technical solutions of the present disclosure essentially or the part contributing to the prior art may be implemented in a form of a software product. The software product is stored in a readable storage medium, such as a floppy disk, a universal serial bus (USB) flash drive, a removable hard disk, a read-only memory (ROM), a random access memory (RAM), a magnetic disk, or an optical disc of a computer, and includes several instructions for instructing a computer device (which may be a personal computer, a server, a network device, and the like) to perform the methods described in the embodiments of the present disclosure.

All or some of the foregoing embodiments may be implemented by means of software, hardware, firmware, or any combination thereof. When software is used to implement the embodiments, the embodiments may be implemented completely or partially in a form of a computer program product.

The computer program product includes one or more computer instructions. When the computer program instructions are loaded and executed on the computer, the procedure or functions according to the embodiments of the present disclosure are all or partially generated. The computer may be a general-purpose computer, a special-purpose computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive Solid State Disk (SSD)), or the like.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for monitoring comprising:
obtaining, by a vehicle to everything server, a plurality of first images captured by a plurality of surround-view cameras of a plurality of preset vehicles from all the plurality of preset vehicles in a monitoring area, where each of the plurality of preset vehicles starts a sentinel mode, each of the plurality of preset vehicles is provided with a corresponding surround-view camera, each of the plurality of surround-view cameras is configured to capture one or more of the plurality of first images of an ambient environment surrounding a corresponding preset vehicle, and each of the plurality of preset vehicles is provided with a preset exterior lamp;
determining, by the vehicle to everything server, one or more second preset vehicles according to one or more second images if one or more suspicious targets of a first preset vehicle appear in the one or more second images, which are captured by the corresponding surround-view camera of the first preset vehicle and are from the plurality of first images, and a definition of each of the one or more suspicious targets in each of the one or more second images is less than a preset value, where the first preset vehicle is one of the plurality of preset vehicles in the monitoring area, the one or more second preset vehicles are one or more of the plurality of preset vehicles in the monitoring area, each of the one or more second preset vehicles is different from the first preset vehicle, and the one or more suspicious targets appear in an illuminating area illuminated by one or more preset exterior lamps of the one or more second preset vehicles; and
prompting, by the vehicle to everything server, the one or more second preset vehicles to turn on the one or more preset exterior lamps.

2. The method according to claim 1, wherein before obtaining, by the vehicle to everything server, the plurality of first images captured by the plurality of surround-view cameras of the plurality of preset vehicles from all the plurality of preset vehicles in the monitoring area, the method further comprises:
determining, by the vehicle to everything server, that the monitoring area is a union set of a plurality of ranges of image capturing of the plurality of surround-view cameras of all the plurality of preset vehicles.

3. The method according to claim 1, determining, by the vehicle to everything server, the one or more second preset vehicles according to the one or more second images further comprising:
determining, by the vehicle to everything server, position information of the one or more suspicious targets according to the one or more second images;
determining, by the vehicle to everything server, that the one or more second preset vehicles are the one or more of the plurality of preset vehicles of which the illuminating area comprises the position information of the one or more suspicious targets, where the illuminating area is illuminated by the one or more preset exterior lamps of the one or more of the plurality of preset vehicles, and the one or more of the plurality of preset vehicles are from all the plurality of preset vehicles in the monitoring area.

4. The method according to claim 3, wherein:
the one or more second preset vehicles are at different orientations of the first preset vehicle, the orientations in the different orientations of the first preset vehicle are from at least two of a group consisting of in front of the first preset vehicle, at a left side of the first preset vehicle, at a right side of the first preset vehicle, and at a rear of the first preset vehicle.

5. The method according to claim 1, after prompting, by the vehicle to everything server, the one or more second preset vehicles to turn on the one or more preset exterior lamps, the method further comprising:
determining, by the vehicle to everything server, determining one or more third preset vehicles excluding the first preset vehicle, where at least one of the one or more suspicious targets of the first preset vehicle appear in one or more third images, which are captured by one or more surround-view cameras of the one or more third preset vehicles and are from the plurality of first images, and the one or more third preset vehicles are from all the plurality of preset vehicles in the monitoring area;
prompting, by the vehicle to everything server, the one or more third preset vehicles to capture one or more videos via the one or more surround-view cameras of the one or more third preset vehicles;
obtaining, by the vehicle to everything server, the one or more videos from the one or more third preset vehicles;
transmitting, by the vehicle to everything server, the one or more videos to a vehicle owner terminal corresponding to the first preset vehicle.

6. The method according to claim 1, determining, by the vehicle to everything server, that the one or more suspicious targets of the first preset vehicle appear in the one or more second images, which are captured by the corresponding surround-view camera of the first preset vehicle and are from the plurality of first images, and the definition of each of the one or more suspicious targets in each of the one or more second images is less than the preset value further comprising:
obtaining, by the vehicle to everything server, one or more images captured by the corresponding surround-view camera of the first preset vehicle if the one or more suspicious targets of the first preset vehicle appear in the one or more second images, which are captured by the corresponding surround-view camera of the first preset vehicle and are from the first images, where the one or more suspicious targets of the first preset vehicle appears in the one or more images captured by the corresponding surround-view camera of the first preset vehicle, and the preset exterior lamp of the first preset vehicle is at a turned on state when the vehicle to everything server obtains the one or more images captured by the corresponding surround-view camera of the first preset vehicle;
determining, by the vehicle to everything server, that the one or more suspicious targets of the first preset vehicle appear in the one or more second images, which are captured by the corresponding surround-view camera of the first preset vehicle and are from the first images and the definition of each of the one or more suspicious targets in each of the one or more second images is less than the preset value if a definition of each of the one or more suspicious targets in each of the one or more images captured by the corresponding surround-view camera of the first preset vehicle is less than the preset value.

7. The method according to claim 1, after prompting, by the vehicle to everything server, the one or more second preset vehicles to turn on the one or more preset exterior lamps, the method further comprising:
controlling, by the vehicle to everything server, the plurality of surround-view cameras of all the plurality of preset vehicles in the monitoring area to track the one or more suspicious targets until the one or more suspicious targets exit from the monitoring area;
predicting, by the vehicle to everything server, one or more fourth preset vehicles of the plurality of preset vehicles during tracking, where the one or more suspicious targets of the first preset vehicle appear in one or more images captured by one or more surround-view cameras of the one or more fourth preset vehicles;
predicting, by the vehicle to everything server, position information of the one or more suspicious targets of the first preset vehicle in the one or more images captured by the one or more surround-view cameras of the one or more fourth preset vehicles; and
determining, by the vehicle to everything server, one or more fifth preset vehicles of the plurality of preset vehicles according to the predicted position information of the one or more suspicious targets of the first preset vehicle in the one or more images captured by the one or more surround-view cameras of the one or more fourth preset vehicles, where the one or more suspicious targets of the first preset vehicle appear in an illuminating area illustrated by one or more preset exterior lamps of the one or more fifth preset vehicles.

8. A vehicle to everything server comprising:
a storage device;
at least one processor; and
the storage device storing one or more programs, which when executed by the at least one processor, cause the at least one processor to:
obtain a plurality of first images captured by a plurality of surround-view cameras of a plurality of preset vehicles from all the plurality of preset vehicles in a monitoring area, where each of the plurality of preset vehicles starts a sentinel mode, each of the plurality of preset vehicles is provided with a corresponding surround-view camera, each of the plurality of surround-view cameras is configured to capture one or more of the plurality of the first images of an ambient environment surrounding a corresponding preset vehicle, and each of the plurality of preset vehicles is provided with a preset exterior lamp;
determine one or more second preset vehicles according to one or more second images if one or more suspicious targets of a first preset vehicle appear in the one or more second images, which are captured by the corresponding surround-view camera of the first preset vehicle and are from the plurality of first images, and a definition of each of the one or more suspicious targets in each of the one or more second images is less than a preset value, where the first preset vehicle is one of the plurality of preset vehicles in the monitoring area, the one or more second preset vehicles are one or more of the plurality of preset vehicles in the monitoring area, each of the one or more second preset vehicles is different from the first preset vehicle, and the one or more suspicious targets appear in an illuminating area illuminated by one or more preset exterior lamps of the one or more second preset vehicles; and
prompt the one or more second preset vehicles to turn on the one or more preset exterior lamps.

9. The vehicle to everything server according to claim 8, further causing the at least one processor to:
determine that the monitoring area is a union set of a plurality of ranges of image capturing of the plurality of surround-view cameras of all the plurality of preset vehicles.

10. The vehicle to everything server according to claim 8, further causing the at least one processor to:
determine position information of the one or more suspicious targets according to the one or more second images;
determine that the one or more second preset vehicles are the one or more of the plurality of preset vehicles of which the illuminating area comprises the position information of the one or more suspicious targets, where the illuminating area is illuminated by the one or more preset exterior lamps of the one or more of the plurality of preset vehicles, and the one or more of the plurality of preset vehicles are from all the plurality of preset vehicles in the monitoring area.

11. The vehicle to everything server according to claim 10, wherein:
the one or more second preset vehicles are at different orientations of the first preset vehicle, the orientations in the different orientations of the first preset vehicle are from at least two of a group consisting of in front of the first preset vehicle, at a left side of the first preset vehicle, at a right side of the first preset vehicle, and at a rear of the first preset vehicle.

12. The vehicle to everything server according to claim 8, further causing the at least one processor to:
determine one or more third preset vehicles excluding the first preset vehicle, where at least one of the one or more suspicious targets of the first preset vehicle appear in one or more third images which are captured by one or more surround-view cameras of the one or more third preset vehicles and are from the plurality of first images, and the one or more third preset vehicles are from all the plurality of preset vehicles in the monitoring area;
prompt the one or more third preset vehicles to capture one or more videos via the one or more surround-view cameras of the one or more third preset vehicles;
obtain the one or more videos from the one or more third preset vehicles;
transmit the one or more videos to a vehicle owner terminal corresponding to the first preset vehicle.

13. The vehicle to everything server according to claim 8, further causing the at least one processor to:
obtain one or more images captured by the corresponding surround-view camera of the first preset vehicle if the one or more suspicious targets of the first preset vehicle appear in the one or more second images which are captured by the corresponding surround-view camera of the first preset vehicle and are from the first images, where the one or more suspicious targets of the first preset vehicle appears in the one or more images captured by the corresponding surround-view camera of the first preset vehicle, and the preset exterior lamp of the first preset vehicle is at a turned on state when the vehicle to everything server obtains the one or more images captured by the corresponding surround-view camera of the first preset vehicle;
determine that the one or more suspicious targets of the first preset vehicle appear in the one or more second images, which are captured by the corresponding surround-view camera of the first preset vehicle and are from the first images and the definition of each of the one or more suspicious targets in each of the one or more second images is less than the preset value if a definition of each of the one or more suspicious targets in each of the one or more images captured by the corresponding surround-view camera of the first preset vehicle is less than the preset value.

14. The vehicle to everything server according to claim 8, further causing the at least one processor to:
control the plurality of surround-view cameras of all the plurality of preset vehicles in the monitoring area to track the one or more suspicious targets until the one or more suspicious targets exit from the monitoring area;
predict one or more fourth preset vehicles of the plurality of preset vehicles during tracking, where the one or more suspicious targets of the first preset vehicle appear in one or more images captured by one or more surround-view cameras of the one or more fourth preset vehicles;
predict position information of the one or more suspicious targets of the first preset vehicle in the one or more images captured by the one or more surround-view cameras of the one or more fourth preset vehicles;
determine one or more fifth preset vehicles of the plurality of preset vehicles according to the predicted position information of the one or more suspicious targets of the first preset vehicle in the one or more images captured by the one or more surround-view cameras of the one or more fourth preset vehicles, where the one or more suspicious targets of the first preset vehicle appear in an illuminating area illustrated by one or more preset exterior lamps of the one or more fifth preset vehicles.

15. A non-transitory storage medium storing a set of commands, when the set of commands being executed by at least one processor of a vehicle to everything server, causing the at least one processor to:
obtain a plurality of first images captured by a plurality of surround-view cameras of a plurality of preset vehicles from all the plurality of preset vehicles in a monitoring area, where each of the plurality of preset vehicles starts a sentinel mode, each of the plurality of preset vehicles is provided with a corresponding surround-view camera, each of the plurality of surround-view cameras is configured to capture one or more of the plurality of the first images of an ambient environment surrounding a corresponding preset vehicle, and each of the plurality of preset vehicles is provided with a preset exterior lamp;
determine one or more second preset vehicles according to one or more second images if one or more suspicious targets of a first preset vehicle appear in the one or more second images which are captured by the corresponding surround-view camera of the first preset vehicle and are from the plurality of first images, and a definition of each of the one or more suspicious targets in each of the one or more second images is less than a preset value, where the first preset vehicle is one of the plurality of preset vehicles in the monitoring area, the one or more second preset vehicles are one or more of the plurality of preset vehicles in the monitoring area, each of the one or more second preset vehicles is different from the first preset vehicle, and the one or more suspicious targets appear in an illuminating area illuminated by one or more preset exterior lamps of the one or more second preset vehicles; and
prompt the one or more second preset vehicles to turn on the one or more preset exterior lamps.

16. The non-transitory storage medium according to claim 15, further causing the at least one processor to:
determine that the monitoring area is a union set of a plurality of ranges of image capturing of the plurality of surround-view cameras of all the plurality of preset vehicles.

17. The non-transitory storage medium according to claim 15, further causing the at least one processor to:
determine position information of the one or more suspicious targets according to the one or more second images;
determine that the one or more second preset vehicles are the one or more of the plurality of preset vehicles of which the illuminating area comprises the position information of the one or more suspicious targets, where the illuminating area is illuminated by the one or more preset exterior lamps of the one or more of the plurality of preset vehicles, and the one or more of the plurality of preset vehicles are from all the plurality of preset vehicles in the monitoring area;
wherein the one or more second preset vehicles are at different orientations of the first preset vehicle, the different orientations of the first preset vehicle are at least two of a group consisting of in front of the first preset vehicle, at a left side of the first preset vehicle, at a right side of the first preset vehicle, and at a rear of the first preset vehicle.

18. The non-transitory storage medium according to claim 15, further causing the at least one processor to:
determine one or more third preset vehicles excluding the first preset vehicle, where at least one of the one or more suspicious targets of the first preset vehicle appear in one or more third images which are captured by one or more surround-view cameras of the one or more third preset vehicles and are from the plurality of first images, and the one or more third preset vehicles are from all the plurality of preset vehicles in the monitoring area;
prompt the one or more third preset vehicles to capture one or more videos via the one or more surround-view cameras of the one or more third preset vehicles;
obtain the one or more videos from the one or more third preset vehicles;
transmit the one or more videos to a vehicle owner terminal corresponding to the first preset vehicle.

19. The non-transitory storage medium according to claim 15, further causing the at least one processor to:
obtain one or more images captured by the corresponding surround-view camera of the first preset vehicle if the one or more suspicious targets of the first preset vehicle appear in the one or more second images which are captured by the corresponding surround-view camera of the first preset vehicle and are from the first images, where the one or more suspicious targets of the first preset vehicle appears in the one or more images captured by the corresponding surround-view camera of the first preset vehicle, and the preset exterior lamp of the first preset vehicle is at a turned on state when the vehicle to everything server obtains the one or more images captured by the corresponding surround-view camera of the first preset vehicle;
determine that the one or more suspicious targets of the first preset vehicle appear in the one or more second images, which are captured by the corresponding surround-view camera of the first preset vehicle and are from the first images and the definition of each of the one or more suspicious targets in each of the one or more second images is less than the preset value if a definition of each of the one or more suspicious targets in each of the one or more images captured by the corresponding surround-view camera of the first preset vehicle is less than the preset value.

20. The non-transitory storage medium according to claim 15, further causing the at least one processor to:
control the plurality of surround-view cameras of all the plurality of preset vehicles in the monitoring area to track the one or more suspicious targets until the one or more suspicious targets exit from the monitoring area;
predict one or more fourth preset vehicles of the plurality of preset vehicles during tracking, where the one or more suspicious targets of the first preset vehicle appear in one or more images captured by one or more surround-view cameras of the one or more fourth preset vehicles;
predict position information of the one or more suspicious targets of the first preset vehicle in the one or more images captured by the one or more surround-view cameras of the one or more fourth preset vehicles;
determine one or more fifth preset vehicles of the plurality of preset vehicles according to the predicted position information of the one or more suspicious targets of the first preset vehicle in the one or more images captured by the one or more surround-view cameras of the one or more fourth preset vehicles, where the one or more suspicious targets of the first preset vehicle appear in an illuminating area illustrated by one or more preset exterior lamps of the one or more fifth preset vehicles.
